(19) United States
(12) Patent Application Publication
(10) Pub. No.: US 2009/0152356 A1
(43) Pub. Date: Jun. 18, 2009

(54) NON-CONTACT MAGNETIC PATTERN RECOGNITION SENSOR

(75) Inventors: Gangi Rajula Reddy, Bangalore (IN); Vipin J. Pillai, Motherwell (GB); Raghavendra Muniraju, Bangalore (IN); Raviprakash Thotadakumbri, Bangalore (IN); Praveen Mavila, Bangalore (IN); Sudheer Veedu, Bangalore (IN); Hong Wan, Plymouth, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/956,807

(22) Filed: Dec. 14, 2007

(51) Int. Cl. G06K 7/08

(52) U.S. Cl. 235/449

(57) ABSTRACT

A magnetic pattern detection system (200) includes a housing (201), and a magnetic detector (100) including at least one magneto resistive (MR) sensor array (144) having an easy axis within the housing. A magnetic field source (151, 152) is within the housing (201), wherein the magnetic field source is operable when turned on to provide a magnetic field to line up random magnetic domains along the easy axis of the MR array (144). An amplifier (170) within the housing (201) is coupled to an output of the MR sensor array (144).

### FIELD OF THE INVENTION

The present invention relates generally to magnetic pattern sensors.

### BACKGROUND

The use of iron oxide as a pigment in black ink has provided a method of reading and validating currency. The small magnetic fields in currency from iron oxide therein provide specific signatures that can be read by magnetic sensors. The detection of magnetic ink is a growing magnetic sensor application and has led to Magnetic Ink Character Recognition (MICR) sensors.

In MICRs, the magnetic sensor averages the signal over the height of the characters as they pass the magnetic sensor. In certain applications (e.g. certain checks), the ink must generally be magnetized in the plane of the paper by passing the checks or other article over a permanent magnet upstream from the sensor location. The magnetized ink produces the magnetic signature that identifies each character as it passes the sensor. Each area produces a positive signal as it approaches and a negative signal as it leaves. For example, magnetic pattern sensors are used to differentiate bank note types and patterns printed with magnetic ink by comparing magnetic signatures by some digital or analog electronic means to a set of known patterns to determine if the measured pattern is valid. Typical applications include ATMs, cash counters, bill changers, ticket machines, automatic vending machines, card readers, and differentiation of E13B codes on gift certificates.

Design of a good magnetic ink reader involves numerous challenges. The reader has to work with a variety of bills from crisp new ones to ragged old ones, and it has to be able to distinguish real bills from fakes. In many cases the device also has to be able to sense the denomination of the bill. Depending on the circuit management noise and magnetic biasing of the machine they can be more or less accurate, such as for identifying counterfeit currency.

Moreover, the reading of currency and some other magnetically patterned articles can be difficult because the amount of magnetic ink in the currency or other article is generally low resulting in a low signal level. For example, the maximum field measured immediately above U.S. currency is generally less than 100 mOe or 8 A/m. This results in the signal often being of similar amplitude as the amplitude of the background noise.

Inductive read heads for MICR are known. Inductive head-based MICR sensors need to be in direct contact with the article (e.g. currency) having the ink to be identified to yield an adequate signal. However, to avoid jamming in high-speed transport mechanisms it is desirable to read the currency or other article while not in contact, such as, from one or more millimeters away. Moreover, in most applications, such as ATMs, cash machines and fake currency identifier in currency counter, the reader needs to be very small in size. What is needed is a non-contact MICR sensor that is provides good sensitivity, resolution and repeatability, and is also compact in size.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

A magnetic pattern detection system includes a housing, and a magnetic detector within the housing comprising at least one magneto resistive (MR) sensor array having an easy axis within the housing and a magnetic field source operable when turned on to provide a magnetic field to line up random magnetic domains along the easy axis of the MR array. An amplifier within the housing is coupled to an output of the MR sensor array. The housing is generally an electrically conducting housing, such as a metal housing, that is operable to allow low frequency magnetic fields coming from documents to be detected to pass through and shield high frequency electromagnetic noise fields coming from the surroundings. The thickness of the housing can generally be in a range from about 0.2 mm to 1 mm.

The MR sensor array can comprise an Anisotropic Magneto-Resistive (AMR) sensor array, such as an AMR array arranged in a four-element Wheatstone bridge configuration. The magnetic field source can comprise a plurality of surface coils, such as first and second surface mount coils located on opposing sides of the MR array. In this arrangement, the first and second coils can be arranged such that when biased a magnetic field produced by one of coils is attracted by the other of the coils.

In one embodiment the detection system further comprises a substrate, wherein the MR sensor array, the magnetic field source and the amplifier are formed on or positioned on the substrate. The substrate can comprise a printed circuit board (PCB) or a substrate having a semiconducting surface (e.g. Si wafer).

In another embodiment of the invention a document handling system including magnetic document verification is provided. The document handling system comprises a magnetic pattern recognition detection system and a means for transferring a document to be verified to the magnetic pattern recognition detection system. The magnetic pattern detection system comprises a housing, and a magnetic detector inside the housing comprising at least one MR sensor array having an easy axis within the housing and a magnetic field source operable when turned on to provide a magnetic field to line up random magnetic domains along the easy axis of the sensor array. An amplifier is coupled to an output of the MR sensor array, wherein the amplifier is within the housing. A processor including associated memory has stored magnetic pattern data, wherein the processor controls operations of the system including analyzing data collected by the magnetic pattern detection system to determine authenticity or identification of the document. The can comprise an ATM, a cash counter, bill changer, ticket machine, automatic vending machine, card reader, or gift certificate differentiator.

A method for validating documents having magnetic material therein using a MR sensor array, wherein the MR array is within an electrically conductive housing. The method comprises reading a magnetic pattern embedded in a document to be identified using the MR array, wherein an electrical signal is generated, amplifying the electrical signal within the housing to provide an amplified electrical signal, comparing the amplified electrical signal to at least one reference signal, and determining an authenticity or identification of the document based on the comparing. The method can further comprise the step of realigning a magnetization vector for the MR array after the reading step. The realigning can comprise generating a field using a first and a second surface mount coil located on opposing sides of the MR array, wherein the first and second coils are arranged and biased such that a magnetic field produced by one of the coils is attracted by the other of the coils.

### FIGURES

A fuller understanding of the present invention and the features and benefits thereof will be accomplished upon review of the following detailed description together with the accompanying drawings, in which:

FIG. 1(A) is a highly simplified circuit drawing of an exemplary magnetic detector according to one embodiment of the invention including an MR sensor array, while FIG. 1(B) shows an exemplary four element Wheatstone bridge anisotropic magnetoresistive (AMR) sensor that can be used as the MR sensor array.

FIG. 2 shows an exploded view of a packaged MR sensor system comprising the exemplary magnetic detector shown in FIG. 1A on a printed circuit board (PCB) that is packaged inside a miniature electrically conductive (e.g. metal comprising) housing.

FIG. 3 is an exemplary circuit which comprises serially connected signal conditioning circuitry and amplification circuitry, according to an embodiment of the invention.

FIG. 4 shows a magnetic sensing system embodied as an automated transaction machine (ATM) system, according to an embodiment of the invention.

FIG. 5A is output voltage vs. time data obtained from a detection system according to the invention in contact with moving U.S. currency.

FIG. 5B is output voltage vs. time data obtained from a detection system according to the invention with an air gap of obtained from moving U.S. currency.

FIG. 6 is output voltage of the sensor array vs. distance to the document data according to the invention for air gaps of 0 (contact), 0.8 mm, 1.6 mm, and 2 mm, for moving U.S. currency.

FIG. 7A is output voltage of the sensor data obtained at a low speed, while FIG. 7B is output voltage of the sensor data obtained at an approximately 10× higher speed, for a contact arrangement using U.S. currency, according to an embodiment of the invention.

FIG. 8 is output voltage data provided by a detector system according to the invention sensor representing a MICR pattern read for a bank check, according to an embodiment of the invention.

### DETAILED DESCRIPTION

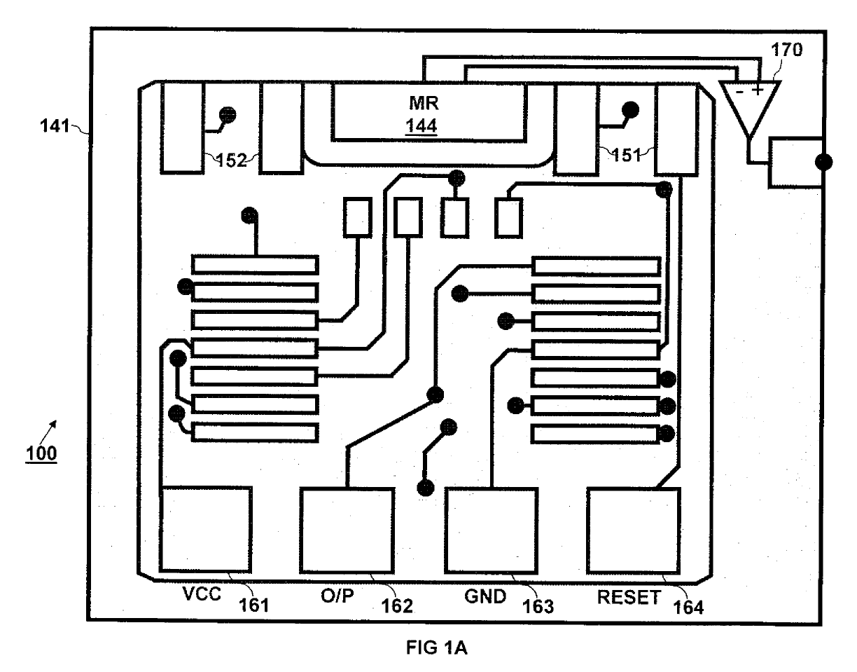

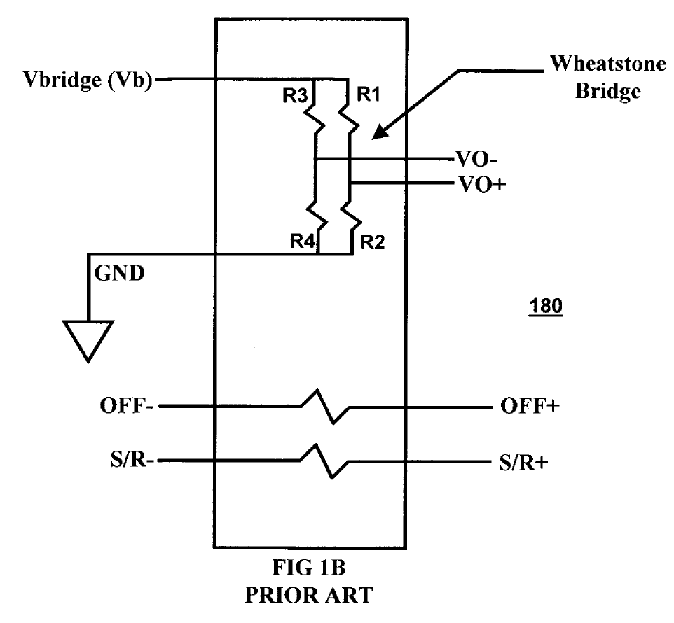

Referring now to FIG. 1A, there is shown one embodiment of the present invention. As shown, the magnetic detector 100 includes a substrate 141 having at least one MR sensor array 144 thereon. Although only a single MR sensor array 144 is shown, a plurality of MR sensor arrays 144 can be arranged in a pattern which matches the magnetic pattern to be detected. When a magnetic pattern is aligned with the MR sensor array 144, the MRs in the MR sensor array 144 provide a change in electrical resistance. The MR sensor array 144 can comprise an anisotropic magnetoresistive (AMR) or giant magnetorestive (GMR) sensor. Magnetic pattern detector systems according to the present invention are generally applicable to any method of producing a magnetic pattern in a document, product, or machine, including but not limited to printed magnetic ink, paper containing magnetic particles, plastic containing magnetic particles, or conventional magnetic media, e.g., magnetic tape or a magnetic layer on film.

In one embodiment of the invention, the substrate 141 comprises a printed circuit board (PCB), and the MR sensor array 144 comprises an AMR sensor array placed on a PCB, such as formed from permalloy (NiFe) films. AMR sensors are known to have an easy axis. In one embodiment, the AMR sensor array 144 is a die which comprises four permalloy MR elements placed on a semiconducting substrate such as the silicon and is connected in Wheatstone bridge configuration (described below relative to FIG., 1B). Such an AMR circuit can be purchased commercially, such as the HMC 1021™ from Honeywell International.

The detector 100 also includes at least one magnetic field source, shown as a pair of surface mount coils 151 and 152, which are on both sides of the MR sensor array 144 and function as electromagnets. The magnetic field sources 151 and 152 are collectively operable when turned on and biased appropriately to provide a magnetic field to line up random magnetic domains along the easy axis of the MR sensor 144, such as following measurement of a document passing nearby having magnetic ink. Thus, to keep the magnetization vector intact of the MR sensor elements when exposed to a disturbing magnetic field, the surface mount coils 151 and 152 realign the magnetization vector in the MR elements. Although the two coils shown 151 and 152 are generally sufficient for realignment, more than two coils can be used.

Generally, the coil arrangement should be such that the field produced by one coil should be attracted by other coil (e.g. Coil 151-NS NS-Coil 152). To provide attraction, the relative direction of the current applied to the coils 151 and 152 can be such that the magnetic field produced by one coil (coil 151) is attracted by the magnetic field produced by the other coil (coil 152). More broadly, any air cored magnet which can be turned on/off (e.g. electromagnet without a ferrous core) may be used with the invention. Regarding field levels and time for the applied field to realign, 40 Gauss with a 1 microsecond pulse generally can be used as approximate minimums. Domain realignment may be performed automatically after a set number of measurements, such as based on microprocessor control, as described below.

The outputs of the MR sensor array 144 are coupled to an amplifier 170, such as a high gain instrumentation amplifier. In one embodiment, the amplifier 170 is also on the substrate 141. However, the amplifier can be off the substrate in another embodiment.

Detector 100 includes pads comprising a power supply pad 161, and O/P pad (Output pin from which the output signal is captured, which is a replica of magnetic pattern) 162, a ground pad 163 and a set/reset pad 164. Pad 164 is used to send signals to coils 151 and 152 to realign the sensor array 144 following disturbance, such as from external disturbing magnetic fields or measurements made. Outputs from MR array 144 are shown coupled to the amplifier 170 using conductive traces formed on the PCB substrate 141.

In another embodiment of the invention, substrate 141 can also comprise an integrated circuit substrate, such as a substrate having a silicon surface (e.g. silicon wafer). MEMS processing can be used to form the respective components on the substrate 141 shown in FIG. 1A.

FIG. 1B shows an exemplary four element Wheatstone bridge AMR sensor 180 that can be use as MR sensor array 144. In the Wheatstone bridge configuration, the manufacturing objective is to create four electrically identical MR elements with diagonal pairs of elements physically identical to react similarly to nearby magnetic fields. As known in the art, the principal of Wheatstone bridges is to create two voltage divider elements (half-bridges), each with normally equal electrical impedances at a null point, or when a sensor has no stimulus. With each half-bridge at its null point, the expected voltage across each divider should be half the total bridge supply voltage (Vb). Thus the Wheatstone bridge output nodes (Vo+, Vo−) should be identical. When the magnetic pattern is aligned with the array, MR elements in the first half of the circuit increase in resistance, and the MR elements in the second half of the circuit decrease in resistance, producing a change in the differential output voltage, allowing the magnetic field to be sensed by measuring the induced differential voltage.

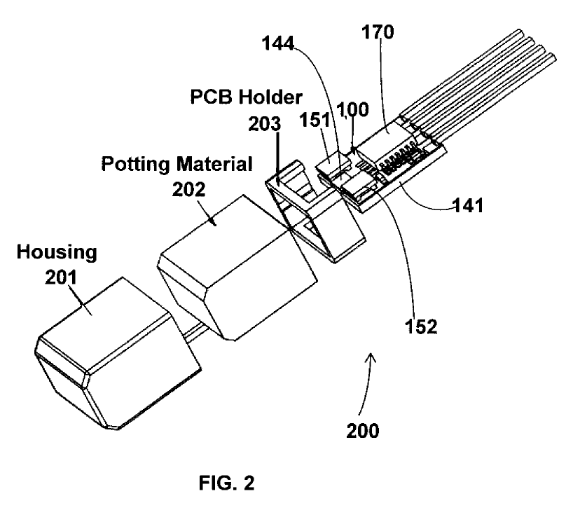

FIG. 2 shows an exploded view of a packaged MR sensor system 200 comprising the exemplary magnetic detector 100 shown in FIG. 1 embodied as a PCB that is packaged inside a miniature electrically conductive (e.g. metal comprising) housing 201. A typical size of the housing is several mms on each size, such as 11×12×8 mm in one particular embodiment. Potting material 202 fits within metal housing 201 and provides protection, such as against vibration, moisture and electrical insulation. The potting material can be any non-conductive soft low temperature curing non-corrosive potting material. Electrical isolation is provided between detector 100 and housing 201 using an air gap. Sensor 100 is secured by PCB holder 203, which is placed within potting material 202. The four (4) connections from the PCB board shown in FIG. 2 can comprise connections from the following pads shown in FIG. 1A, Vcc 161, O/P 162, GND 163 and Set/Reset 164.

The packaged amplified MR sensor system 200 provides small, low cost, magnetic pattern sensor that could be mounted in a variety of magnetic pattern detection systems, such as an ATM. This also helps in lowering installation costs and eliminates secondary operations.

The present Inventors have found that the magnetic field from currency and other magnetic ink comprising articles to be measured for typical translation speeds is at a low frequency as compared to noise fields which come from the surroundings, such as from currency driving mechanisms, for example from motors or any other switched mode power supply. Thus, electrically conducting housing 201 is configured to act as a shield (provide high attenuation) for the high frequency electromagnetic fields (noise), but is configured to provides a low attenuation pathway for the magnetic signal from the currency or other magnetic ink comprising article to the sensor array 144. In one embodiment metal housing 201 comprises a copper alloy, such as brass. Other materials generally suitable for housing 201 include non-ferromagnetic materials, such as non-ferromagnetic metals. The housing material should not be too thick as it can reduce the magnetic field seen by the MR sensor array. In one embodiment, the housing material comprises brass and the thickness of the brass is generally between 0.1 to 1 mm, such as around 0.5 mm.

Raw signals from MR sensor array are known to be generally weak. A significant feature regarding the present invention that has been found to provide good signal to noise ratios for MR-based detection systems according to embodiments of the invention is a proximately located amplifier 170 or other amplification circuitry which provides a high gain, such as around 105. Proximate as used herein refers to generally being located no more than about 50 mm from the output of the MR sensor array, such as 2-20 mms away. Proximate amplifier location has been found to minimize electromagnetic interference (noise) that can lead to saturation of the amplifier output.

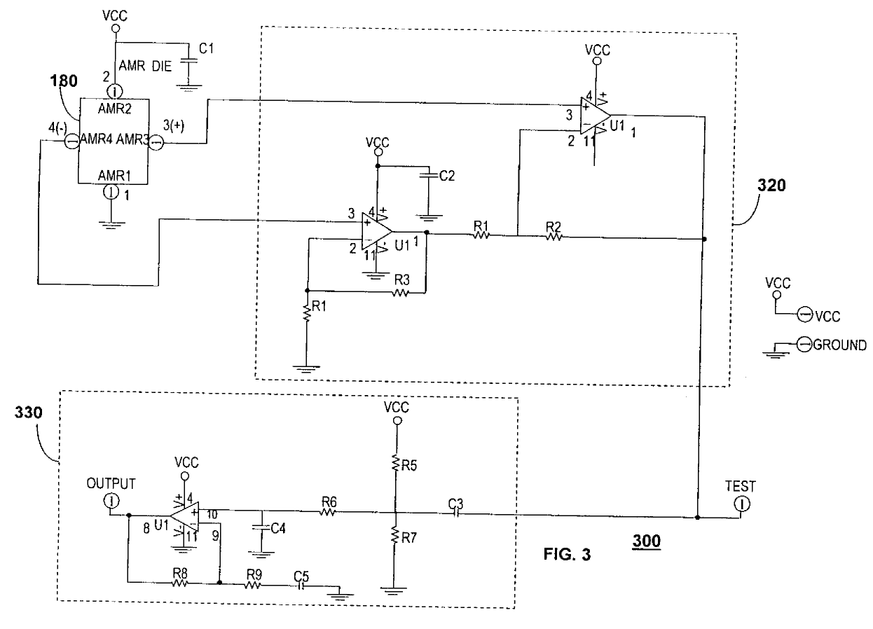

FIG. 3 is an exemplary circuit 300 which comprises serially connected signal conditioning circuitry 320 and amplification circuitry 330. Signal conditioning circuitry 320 and amplification circuitry 330 comprise amplifiers. The MR array is shown as the four element Wheatstone bridge AMR sensor 180 shown in FIG. 1B. The node shown as “Test” represents the signal output, while the “Output” node represents the amplified output.

In one embodiment, the amplifier output is digitized by an A/D converter and signal processing on the resulting signal is performed by a DSP. The format of the digital output is generally specific to a given customer and will generally be an add-on feature.

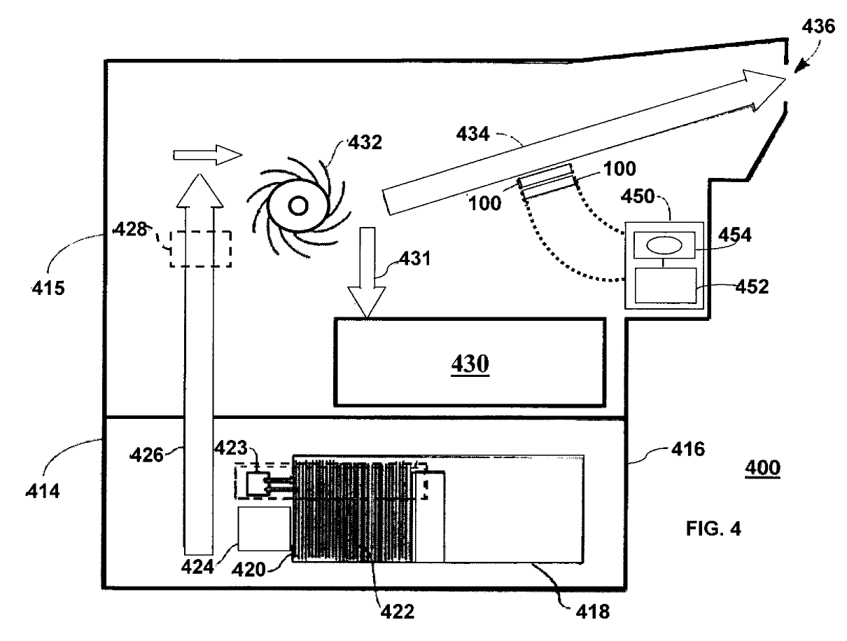

FIG. 4 shows a magnetic sensing system 400. System 400 can be, for example, an ATM, a cash counter, bill changer, ticket machine, automatic vending machine, card reader, or gift certificate differentiator. For the discussion below, system 400 is described as being an automated transaction machine (ATM) system, such as an ATM adapted from the conventional components in the ATM system disclosed in U.S. Pat. No. 7,230,223 to Jesperson et al. System 400 includes a pick module 414 mounted beneath a presenter module 415 and releasably coupled thereto. The pick module 414 has a chassis into which a currency cassette 418 is slideably inserted. When in situ, the chassis 416 and cassette 418 co-operate to present an aperture (defined by a frame 420) in the cassette 418 through which banknotes (e.g. currency) 422 are picked. The pick module 414 includes a sensor station 423 and a pick unit 424 for picking individual banknotes 422 from the inserted currency cassette 418.

System 400 also has a transport arrangement 426 (shown as an arrow for simplicity) for transporting picked banknotes 422 from the pick module 414 to a note thickness sensing site 428 within the presenter module 415. The transport arrangement 426 may be implemented by any suitable mechanism, such as a gear train, stretchable endless belts, skid plates, and the like.

At the note thickness sensing site 428 the thickness of the transported banknote 422 is sensed to ensure that only one banknote has been picked. Suitable sensors may include one or more of linear variable differential transducers (LVDTs), optical sensors, strain gauge sensors, Hall effect sensors, capacitive sensors, and such like. In this embodiment an optical sensor is used.

At the sensing site 428, if multiple banknotes 422 have been picked in a single operation (that is, if a faulty pick has occurred), then these multiple banknotes are diverted to a purge bin 430 via a purge transport 431 (shown as a block arrow for clarity). The purge transport 431 can be in the form of a pivoting belt that allows the banknotes to fall into the purge bin 430 under the influence of gravity. If only a single banknote 422 has been picked, then this banknote is verified in its amount by a reading operation provided by magnetic detector 100, which is shown including a pair of detector systems 100 according to the invention. Detectors 100 are communicable coupled to processor 452 as described below.

The bunch of banknotes is then transported by a bunch note presenter 434 (shown as a block arrow for clarity) from the stacking wheel 432 to an exit port 436 in the form of a shuttered aperture, thereby allowing a customer to remove the bunch of banknotes from a currency dispenser via the exit port 436 shown.

System 400 includes a controller 450 for controlling the operation thereof. The controller 450 comprises a processor 452 and associated memory 454, such as random access memory (RAM). The associated memory 454 includes reference magnetic patterns allowing identification of a plurality of magnetic patterns associated with respective currencies. Processor 452 controls operation of the system 400 by activating and de-activating motors (not shown), analyzing data collected including data collected by detectors 100, and initiating domain realignment automatically after one or more measurements are made.

### EXAMPLES

It should be understood that the Examples described below are provided for illustrative purposes only and do not in any way define the scope of the invention.

A test fixture was developed to evaluate a prototype detection AMR-based detection system according to the invention. The detection system was designed to read the magnetic ink from various currencies. Different currencies generally provide different magnetic strengths and it is generally advisable for the air gap to be adjusted based on magnetic field strength. For example, a higher magnetic strength currency may be read effectively from a 2 mm distance, but a low magnetic field strength currency may be read a distance of 0.5 mm to obtain a sufficient signal.

### A. Repeatability

The repeatability of the sensor output is generally important in identifying and validating currencies and other documents. The repeatability was checked at different speeds and at different air gaps.

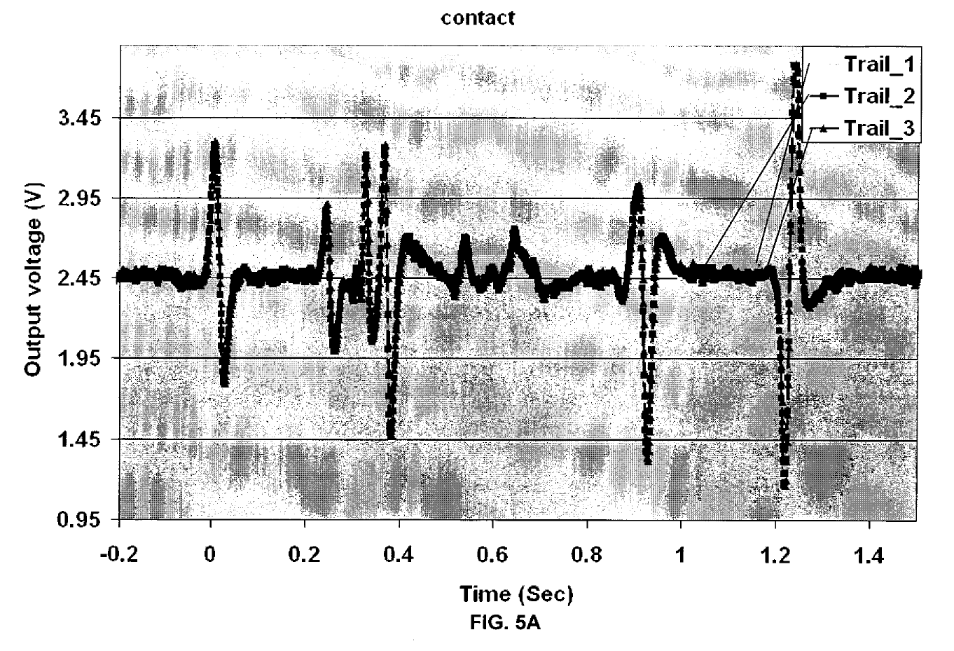

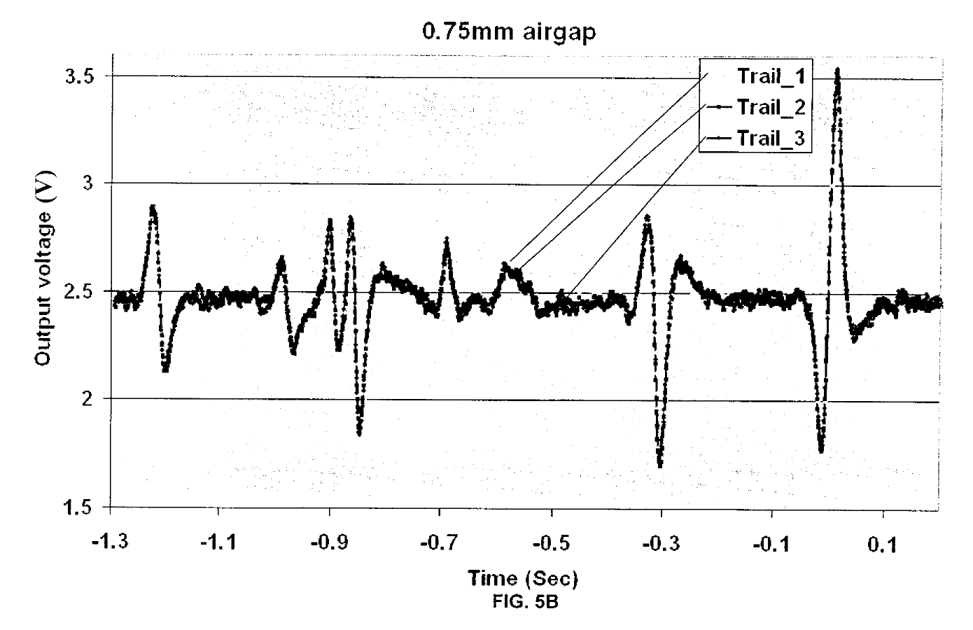

Generally, the magnetic patterns on the various currencies were previously derived and stored in a common database. When an unknown currency passes under the sensor, the output voltage of the sensor was captured and compared with the magnetic pattern from the master database. As shown in the FIG. 5A for U.S. currency, the sensor output was tested three times and its output voltage plotted against the time (shown as Trail_1, Trail_2, and Trail_3), wherein the sensor was in contact with the currency (no air gap) and the currency was moved at a speed of 132 mm/sec. The three trails shown essentially superimpose on one another demonstrating excellent repeatability of the sensor output. The sensor signal conditioning is designed in such away that the output voltage of the sensor swings with reference to the 2.5 volt midline shown.

The repeatability of the sensor output was also tested wherein the sensor array was 0.75 mm away (0.75 mm air gap) from the currency. The currency was again driven at a speed of 132 mm/sec. It can be seen by comparing the data in FIG. 5B to that of FIG. 5A that at an air gap of 0.75 mm the sensor repeatability not measurably affected.

### B. Air Gap Distance Variation

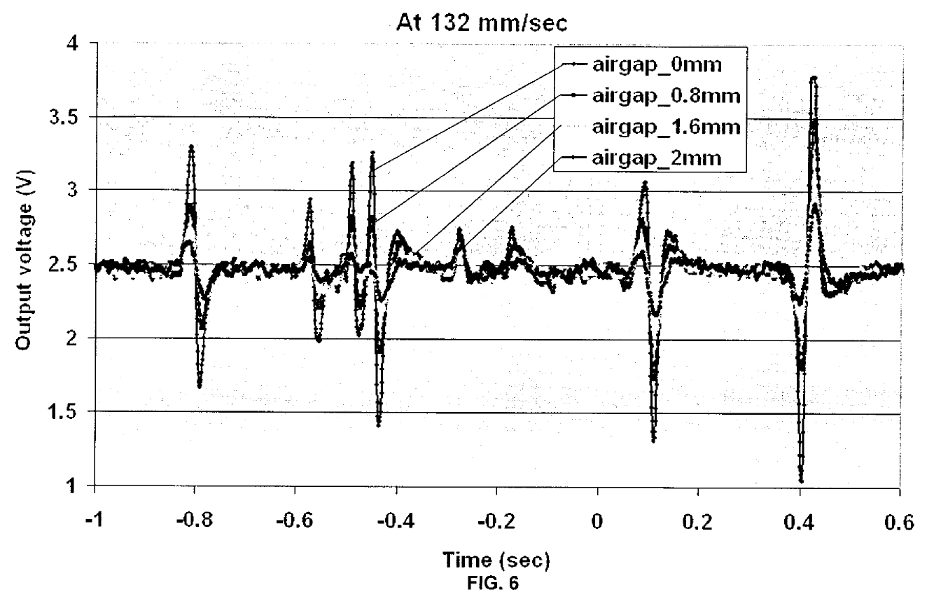

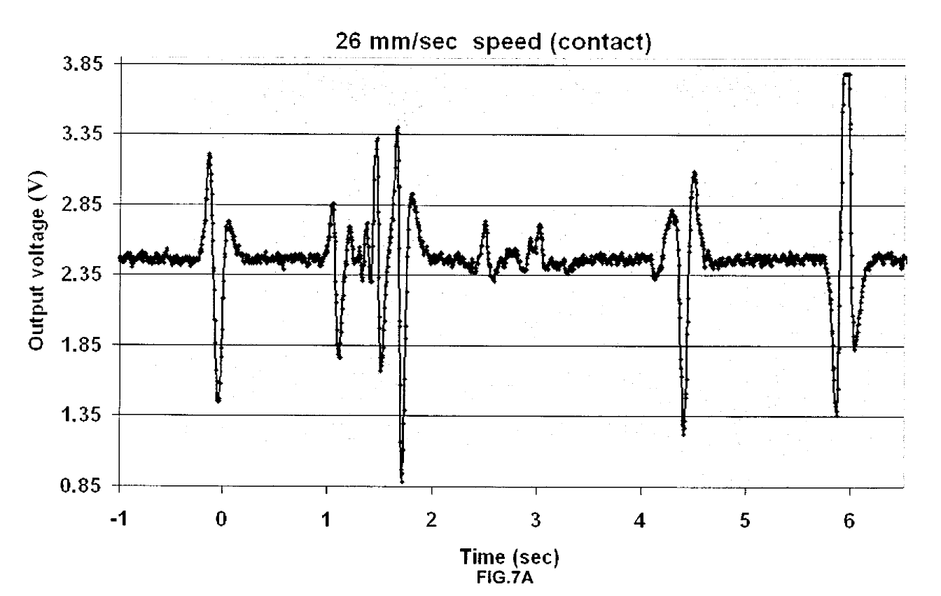

The maximum field measured immediately above U. S. currency is known to generally be less than about 100 mOe or 8 A/m. To avoid jamming in high-speed transport mechanisms it is desirable to read the currency from a sufficient distance away to avoid jamming, such as 1 mm or more. MR sensor-based systems according to the invention were studied at different air gaps and at different speeds. FIG. 6 shows how the output voltage of the sensor array according to the invention at air gaps of 0 (contact), 0.8 mm, 1.6 mm, and 2 mm. The currency was again driven at a speed of 132 mm/sec. The output voltage signal is seen to drop down as the distance between the currency and the sensor increases. The sensor output is significant enough to validate the U.S. currency even at a distance 1.6 mm. It can also be observed that beyond 2 mm the sensor output voltage is close to the noise signal thus lowering the signal to noise ratio significantly.

### C. Speed

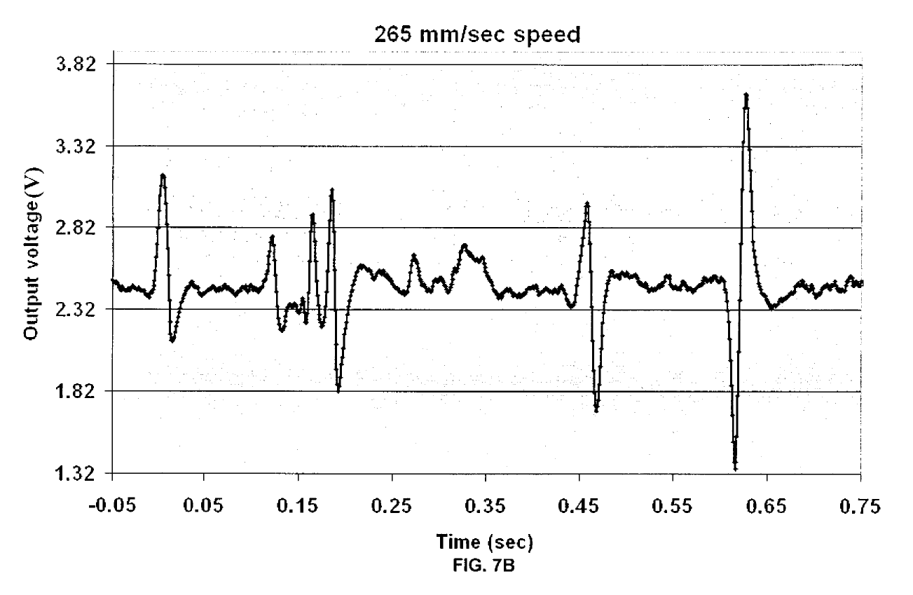

The output voltage of conventional inductive sensors is highly dependent on the speed of motor which drives the currencies under the sensor. As the speed of the sensor increases the output of the conventional inductive sensor starts increasing from the faraday's law of electromagnetic induction. In contrast, the output of MR-based sensors according to the invention have been found to be significantly less dependent on the speed of the currency. FIG. 7A shows the output voltage of the sensor obtained at a lower speed 26 mm/sec, while FIG. 7B shows the output voltage of the sensor obtained at a higher speed of 265 mm/sec, for a contact arrangement using U.S. currency.

### D. Magnetic Pattern On Other Documents

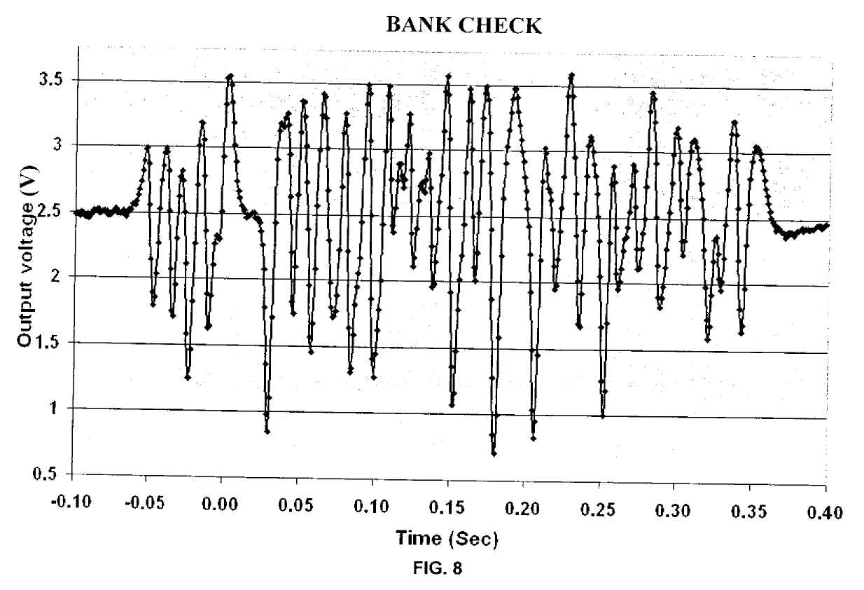

Magnetic patterns were detected on other documents, such as various bank checks, using MR-based sensors according to the invention. As noted above, there are certain checks which need to be magnetized before passing under the sensors. FIG. 8 shows the MICR pattern read using a detector system according to the invention for a bank check. From FIG. 8 it is evident that each peak represents the corresponding magnetic character on the check. In this way magnetic ink character can be read and validated.

In the preceding description, certain details are set forth in conjunction with the described embodiment of the present invention to provide a sufficient understanding of the invention. One skilled in the art will appreciate, however, that the invention may be practiced without these particular details. Furthermore, one skilled in the art will appreciate that the example embodiments described above do not limit the scope of the present invention and will also understand that various modifications, equivalents, and combinations of the disclosed embodiments and components of such embodiments are within the scope of the present invention.

Moreover, embodiments including fewer than all the components of any of the respective described embodiments may also within the scope of the present invention although not expressly described in detail. Finally, the operation of well known components and/or processes has not been shown or described in detail below to avoid unnecessarily obscuring the present invention. One skilled in the art will understood that even though various embodiments and advantages of the present Invention have been set forth in the foregoing description, the above disclosure is illustrative only, and changes may be made in detail, and yet remain within the broad principles of the invention. For example, some of the components described above may be implemented using either digital or analog circuitry, or a combination of both, and also, where appropriate may be realized through software executing on suitable processing circuitry. The present invention is to be limited only by the appended claims. The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

We claim:

1. A magnetic pattern detection system, comprising:
a housing;
a magnetic detector comprising at least one magneto resistive (MR) sensor array having an easy axis within said housing;
a magnetic field source within said housing, said magnetic field source operable when turned on to provide a magnetic field to line up random magnetic domains along said easy axis of said MR array, and
an amplifier coupled to an output of said MR array, wherein said amplifier is within said housing.

2. The detection system of claim 1, wherein said housing is an electrically conducting housing, said electrically conducting housing operable to allow low frequency magnetic fields coming from documents to be detected to pass through and shield high frequency electromagnetic noise fields coming from surroundings.

3. The detection system according to claim 1, wherein said housing is metal comprising and in a thickness range of 0.2 mm to 1 mm.

4. The detection system of claim 1, wherein said MR sensor array comprises an Anisotropic Magneto-Resistive (AMR) sensor array arranged in a four-element Wheatstone bridge configuration.

5. The detection system of claim 1, wherein said magnetic field source comprises a first and a second surface mount coil located on opposing sides of said MR array.

6. The detection system of claim 5, wherein said first and second coils are arranged such that when biased a magnetic field produced by one of said coils is attracted by the other of said coils.

7. The detection system of claim 1, further comprising a substrate, wherein said MR array, said magnetic field source and said amplifier are formed on said substrate or positioned on said substrate.

8. The detection system of claim 7, wherein said substrate comprises a printed circuit board (PCB).

9. The detection system of claim 7, wherein said substrate comprises a substrate having a semiconducting surface.

10. A document handling system including magnetic document verification, comprising:
a magnetic pattern detection system, and
a means for transferring a document to be verified to said magnetic pattern recognition detection system, wherein said magnetic pattern detection system comprises:
a housing;
a magnetic detector comprising at least one magneto resistive (MR) sensor array having an easy axis within said housing;
a magnetic field source within said housing, said magnetic field source operable when turned on to provide a magnetic field to line up random magnetic domains along said easy axis of said MR array, and
an amplifier coupled to an output of said MR sensor array, wherein said amplifier is within said housing, and a
processor including associated memory having stored magnetic pattern data, said processor controlling operations of said system including analyzing data collected by said magnetic pattern detection system to determine authenticity or identification of said document.

11. The system of claim 10, wherein said magnetic field source comprises a first and a second surface mount coil located on opposing sides of said MR array, said first and second coils being arranged such that when biased a magnetic field produced by one of said coils is attracted by the other of said coil.

12. The system of claim 10, wherein said housing is an electrically conducting housing, said metal housing operable to allow low frequency magnetic fields to pass through and shield noise fields from surroundings.

13. The system of claim 10, wherein said system comprises an ATM, a cash counter, bill changer, ticket machine, automatic vending machine, card reader, or gift certificate differentiator.

14. A method for validating documents having magnetic material therein using magnetic detector comprising a magneto-resistive (MR) sensor array, wherein said detector is within an electrically conductive housing, comprising:
reading a magnetic pattern embedded in a document to be identified using said MR array, wherein an electrical signal is generated;
amplifying said electrical signal within said housing to provide an amplified electrical signal;
comparing said amplified electrical signal to at least one reference signal, and
determining an authenticity or identification of said document based on said comparing.

15. The method of claim 14, further comprising the step of realigning a magnetization vector in said MR array after said reading step.

16. The method of claim 15, wherein said realigning comprises generating a field using a first and a second surface mount coil located on opposing sides of said MR array, said first and second coils being arranged and biased such that a magnetic field produced by one of said coils is attracted by the other of said coil.
